(19) United States
(12) Patent Application Publication
(10) Pub. No.: US 2009/0210620 A1
(43) Pub. Date: Aug. 20, 2009

(54) Method to handle demand based dynamic cache allocation between SSD and RAID cache

(76) Inventors: Mahmoud K. Jibbe, Wichita, KS (US); Senthil Kannan, Rediarpalayam (IN)

Correspondence Address: LSI Corporation c/o Suiter Swantz pc llo, 14301 FNB Parkway, Suite 220, Omaha, NE, 68154, US

(21) Appl. No.: 12/070,531

(22) Filed: Feb. 19, 2008

(51) Int. Cl. G06F 12/00

(52) U.S. Cl. 711/114; 711/E12.001

(57) ABSTRACT

An apparatus and method to dynamically allocate cache in a SAN controller between a first fixed cache comprising traditional RAID cache comprised of RAM and a second, scalable RAID cache comprising of SSDs (Solid State Devices). The method is dynamic and switches between the first and second cache depending on IO demand.

### CROSS-REFERENCE TO RELATED APPLICATIONS

[none]

### BACKGROUND OF THE INVENTION

1. Field of Invention

The present invention relates generally to the art of cache allocation in a RAID controller.

2. Description of Related Art

RAID (Redundant Array of Independent Disks) is a storage system used to increase performance and provide fault tolerance. RAID is a set of two or more hard disks and a specialized disk controller that contains the RAID functionality. RAID improves performance by disk striping, which interleaves bytes or groups of bytes across multiple drives, so more than one disk is reading and writing simultaneously (e.g., RAID 0). Fault tolerance is achieved by mirroring or parity. Mirroring is 100% duplication of the data on two drives (e.g., RAID 1).

A volume in storage is a logical storage unit, which is a part of one physical hard drive or one that spans several physical hard drives.

A cache a form of memory stating area that is used to speed up data transfer between two subsystems in a computer. When the cache client (e.g. a CPU, a RAID controller, an operating system and the like that accessing the cache) wants to access a datum in a slower memory, it first checks the faster cache. If a datum entry in cache can be found with a tag matching that of the desired datum, the datum in the entry is used instead of accessing the slower memory, a situation known as a cache hit. The alternative is when the cache is consulted and found not to contain a datum with the desired tag, known as a cache miss. A cache miss is a failure to find the required instruction or data item in the cache. When a cache misses, the item is read from the main memory, which is slower than the cache (e.g. secondary storage such as a hard drive), which increases the data latency. A prefetch is to bring data or instructions into a higher-speed storage or memory before it is actually processed.

A Storage Area Network (SAN) often connects multiple servers to a centralized pool of disk storage. A SAN can treat all the storage as a single resource, improving disk maintenance and backups. In some SANs, the disks themselves can copy data to other disks for backup without any computer processing overhead. The SAN network allows data transfers between computers and disks at high peripheral channel speeds, with Fibre Channel as a typical high-speed transfer technology, as well as transfer by SSA (Serial Storage Architecture) and ESCON channels. SANs can be centralized or distributed; a centralized SAN connects multiple servers to a collection of disks, while a distributed SAN typically uses one or more Fibre Channel or SCSI switches to connect nodes. Over long distances, SAN traffic can be transferred over ATM, SONET or dark fiber. A SAN option is IP storage, which enables data transfer via IP over fast Gigabit Ethernet locally or via the internet.

A solid state disk or device (SSD) is a disk drive that uses memory chips instead of traditional rotating platters for data storage. SSDs are faster than regular disks because there is zero latency, as there is no read/write head to move as in a traditional drive. SSDs are more rugged than hard disks. SSDs may use non-volatile flash memory; or, SSDs may use volatile DRAM or SRAM memory backed up by a disk drive or UPS system in case of power failure, all of which are part of the SSD system. At present, in terms of performance, a DRAM-based SSD has the highest performance, followed by a flash-based SSD and then a traditional rotating platter hard drive.

Turning attention to FIG. 1, showing prior art, the RAID 100 has a RAID controller 105 that has a predefined and fixed local cache (typically RAM 110) for IO (Input/Output) processing. When the cache misses, latency is increased as the IO request has to be transacted between the hard drives and the initiator of the data request. The RAID 100 has ‘N’ number of volumes, represented as Lun0, Lun1 to LunN. All these volumes LUNs use the fixed local cache (RAM) for pre-fetching the relevant data blocks. This local cache becomes the bottle neck when it tries to serve different OSes/applications residing on different LUNs, as well as with any increase in the number of volumes LunNs as the SAN environment is scaled up.

There are, however, several disadvantages with the existing system of FIG. 1. First, the local RAID cache is of fixed capacity and there is no means to increase the capacity based on SAN environment demand. Second, current cache mechanisms require BBU (Battery Back Up) to protect the dirty data or cache hits in RAM, in case of data loss, e.g. due to a power failure. Third, the current cache memory for the existing system of FIG. 1 is limited in size (with a maximum of between 32 to 128 GB RAM). By contrast, a SSD like in the present invention may currently store up to 750 GB.

What is lacking in the prior art is a method and apparatus for an improved system to allocate cache for a RAID SAN, such as taught in the present invention.

### SUMMARY OF THE INVENTION

Accordingly, an aspect of the present invention is an improved apparatus and method to cache data in a RAID configuration.

A further aspect of the present invention is an apparatus and method of introducing a scalable cache repository in a RAID SAN.

Another aspect of the present invention is an apparatus and method of employing SSD for a RAID SAN cache.

A further aspect of the present invention is to make the cache in a RAID controller be scalable, depending on demand.

Thus the present invention enables a fast, scalable cache for a RAID controller in a RAID SAN.

The sum total of all of the above advantages, as well as the numerous other advantages disclosed and inherent from the invention described herein, creates an improvement over prior techniques.

The above described and many other features and attendant advantages of the present invention will become apparent from a consideration of the following detailed description when considered in conjunction with the accompanying drawings.

### BRIEF DESCRIPTION OF THE DRAWINGS

Detailed description of preferred embodiments of the invention will be made with reference to the accompanying drawings. Disclosed herein is a detailed description of the best presently known mode of carrying out the invention. This description is not to be taken in a limiting sense, but is made merely for the purpose of illustrating the general principles of the invention. The section titles and overall organization of the present detailed description are for the purpose of convenience only and are not intended to limit the present invention.

FIG. 1 is a schematic of prior art.

FIG. 2 is a schematic of the present invention.

FIG. 3 is a flowchart for the present invention.

It should be understood that one skilled in the art may, using the teachings of the present invention, vary embodiments shown in the drawings without departing from the spirit of the invention herein. In the figures, elements with like numbered reference numbers in different figures indicate the presence of previously defined identical elements.

### DETAILED DESCRIPTION OF THE INVENTION

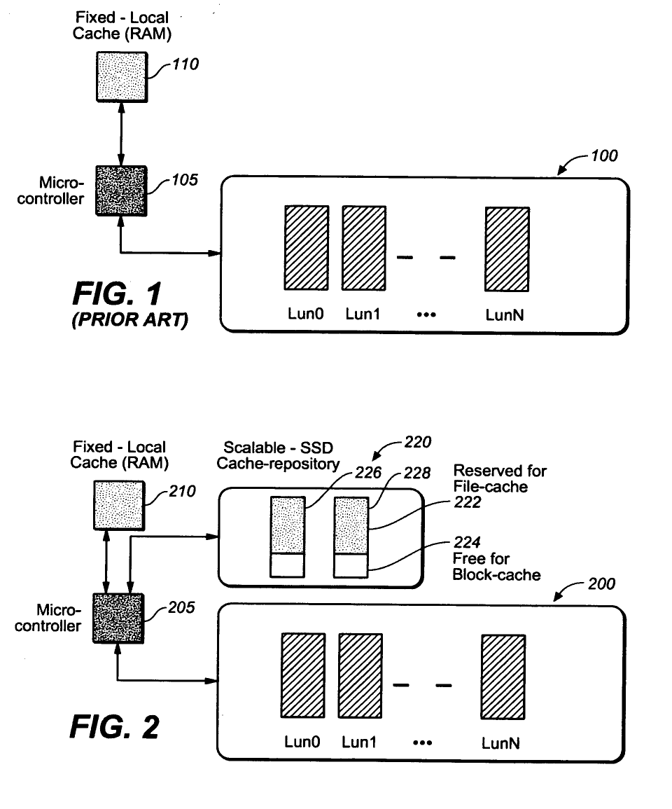

Turning attention to FIG. 2, there is shown a schematic of the present invention. A RAID microcontroller 205 controls the peripherals such as one or more storage devices having logical storage units comprising volumes Lun0, Lun1, . . . LunN, which may be in a RAID SAN 200, such as a distributed network. The microcontroller communicates with one or more processors (not shown) on a bus, and provides data to the processor(s), as is known per se. A fixed local cache 210, typically RAM, communicates with the microcontroller 205 which speeds up the data requests from a processor to the microcontroller. A second local cache, which is termed a scalable cache depository 220, also is provided in parallel to the fixed local cache 210 to communicate with microcontroller 205 for cache hits. The scalable cache depository 220 comprises one or more SSDs (solid state devices or solid state disks) that serve as memory for cache. Each SSD is partitioned into two areas, one reserved for file-cache 222 and one reserved for block-cache 224, which may be reserved by the controller 205 during the startup sequence for the RAID. File cache integrates the buffer cache and page cache to provide coherency for file access; storage accessed in blocks in cache is referred as cache block. The microcontroller 205 is meant as a memory controller or array controller (the storage controller). The memory/array controller 205 directly talks to fixed local cache 210 or the scalable cache-repository 220, dynamically switching between them based on increased IO demand.

The scalable cache depository 220 is scalable because more SSDs 226, 228 may be added if greater cache memory is desired, and the controller's cache can be increased dynamically as the SAN environment scales up. The SSDs may be hot-pluggable for field upgrade benefits. The capacity and percentage of reservation for file-cache and block-cache may be predefined to some predetermined level in the controller 205 itself, or equivalently it can be set by a user through suitable software.

When a cache-miss is observed in FIG. 2, in particular when a cache-miss occurs at the fixed local (RAM) cache 210, the controller 205 switches to the cache-repository 220, somewhat analogous to how L1 and L2 cache work in a microprocessor; thus cache-repository 220 feeds into the microcontroller (storage controller) 205. As IO demand goes higher, the switching between controller 205 and fixed local cache 210 changes to switching between controller 205 and cache-repository 220, and remains in that state to meet the IO demand as long as it is required.

The switching between the fixed cache 210 and the controller 205 and the cache repository 220 and the controller 205 is dynamic, based on the IO demand. Once switching commences, the next prefetch is done to the cache repository 220 directly and not to the fixed local (RAM) cache 210. In the event there are limited or no prefetch actions on the cache repository 220, the controller 205 may switch back to the fixed local cache 210.

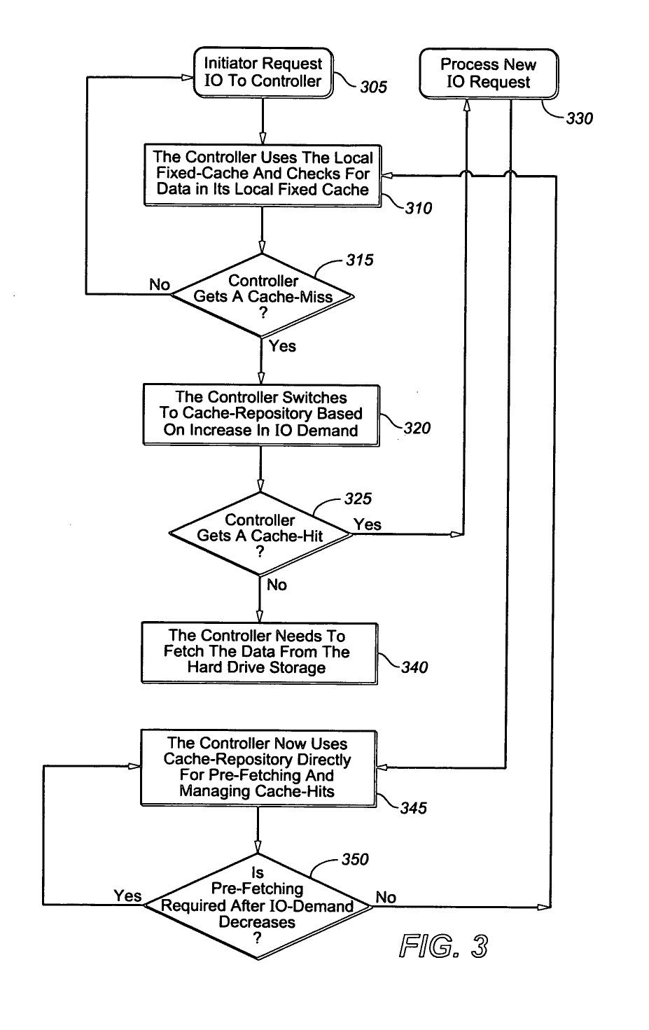

Turning attention now to FIG. 3, there is shown the operation flow of the present invention. An initiator will make an IO request to the storage controller. The controller 205 checks to see if there is any cache-miss at the local fixed cache 210 (RAM). If there is cache-miss the controller 205 uses the extra cache space from the cache repository 220, which are formed by one or more SSDs. If the IO demand reduces, the controller 205 returns to the fixed cache 210.

Thus, in FIG. 3 a first step, indicated by step box 305 labeled “Initiator Request IO To Controller”, an initiator (e.g. a processor) requests IO data from the controller 205. The flow continues to step box 310 labeled “The Controller Uses The Local Fixed-Cache And Checks For Data In Its Local Fixed Cache”, where the controller 205 checks to see if the local fixed cache 210 (RAM) has required data in its cache. If there is no cache-miss, then there is no need to check the cache repository 220 and the program continues along the “No” branch of the decision diamond box 315 labeled “Controller Gets A Cache-Miss?” and back to box 305, since the IO request has been addressed by the local fixed cache 210. Otherwise, if there is a cache-miss at local fixed cache 210, the program continues along the “Yes” branch of the decision box 315 to the step box 320 labeled “The Controller Switches to Cache-Repository Based on Increase in IO Demand”. At this point, the system will switch to the cache repository 220 to seek cache data, and the total cache capacity is increased by using the free space of the SSD cache repository 220.

At decision diamond box 325 labeled “Controller Gets A Cache Hit?”, the system continues back to box 330 labeled “Process New IO Request” if the controller gets a cache-hit, and the process continues from there, otherwise, flow continues to the step box 340 labeled “The Controller Needs To Fetch The Data From The Hard Drive Storage”, and data is fetched from secondary memory comprising the hard drive(s).

From box 330, once the controller 205 uses the cache repository 220 rather than the fixed local cache 210, in response to increased IO demand, flow will continue to the step box 345 labeled “The Controller Now Uses Cache-Repository Directly For Pre-Fetching And Managing Cache-Hits”.

At this point, at box 345, the controller 205 finds the data needed at the cache repository 220 rather than fixed local cache 210, and henceforth uses the cache repository 220 directly for managing cache hits, bypassing the fixed local cache 210 (RAM). This bypassing of the fixed local cache continues until such time that activity on prefetch decreases below some predetermined threshold limit, which can be arbitrarily set. Thus at decision diamond step 350, labeled “Is Pre-Fetching Required After IO Demand Decreases?”, the controller 205 can dynamically switch back to the fixed local cache 210 (RAM) when not much activity is found on prefetch in the cache repository 220 as IO demand decreases below some predetermined but arbitrary level, as indicated by following the “No” branch of decision diamond 350 to the box 310. However, if IO demand increases or stays above the predetermined limit, the flow of the program for the present invention continues along the “Yes” branch of the decision diamond 350, to box 345, and the program continues as before.

The RAID controller cache of the present invention is scalable as demand increases; the SSD used can be a RAID 1 volume created on the storage system, such as a SAN, using SSD drives. The SSD drives themselves may be hot-pluggable, allowing advantageous field upgrades. The SSDs themselves, depending on the model, may be as fast as memory DIMM memory modules. Further, any SSD failures can be recovered by GHS (Global Hot Spare) via a RAID 1 mechanism. Global Hot Spare is for drive failure; when a drive fails, the array controller will reconstruct the data of any failed drive from any RAID volume/Volume group/Logical array managed by the array controller on the Global Hot spare. If the failed drive is replaced by a good drive, the array controller then copies the data of Global Host Spare to the good drive.

The advantages of the present invention include dynamically allocating the size of cache, using scalable and hot-swappable devices such as SSDs. Using SSDs also provides faster IO transactions and smaller latency than using traditional hard drive access. Consequently, a performance boost occurs with reduced latency, as IO requests to traditional hard drives are avoided as much as possible. The disadvantages include using SSD, which increases the cost of manufacturing. However, the cost of SSD drives has dropped over the last two years, and should continue to fall.

Usage of the present invention is a SAN environment, where there are block-caching requirements. The present invention can also fit in the middle of a file-caching SANS as well, where there are not as many OS/Application variants. File Caching SAN is a SAN where the hosts/initiators are issuing file system IO to storage array and the page file/buffer is cached. Block-caching SAN is a SAN where there is a Block Storage array/controller. Those storage arrays have cache on its array controller at block level.

Although the present invention has been described in terms of the preferred embodiments above, numerous modifications and/or additions to the above-described preferred embodiments would be readily apparent to one skilled in the art.

It is intended that the scope of the present invention extends to all such modifications and/or additions and that the scope of the present invention is limited solely by the claims set forth below.

We claim:

1. A RAID controller comprising:
a controller for controlling a plurality of drives comprising a RAID;
a first cache for caching data from said plurality of drives and communicating with said RAID controller;
a second cache for caching data from said plurality of drives and communicating with said RAID controller;
wherein said controller communicates with said second cache after communicating with said first cache and obtaining a cache miss.

2. The invention according to claim 1, wherein:
the second cache comprises a solid state disk (SSD).

3. The invention according to claim 2, wherein:
said SSD comprises a plurality of solid state disks (SSDs).

4. The invention according to claim 3, wherein:
said SSDs are partitioned into areas for file-cache and for block-cache; and,
said first cache is RAM.

5. The invention according to claim 4, wherein:
the SSDs capacity and percentage of reservation are defined to some predetermined level.

6. The invention according to claim 3, wherein:
the controller communicates with said SSDs when IO demand with the controller exceeds a predetermined limit.

7. The invention according to claim 1, wherein:
said second cache comprises a plurality of caches and said plurality of caches are arranged to be scalable.

8. The invention according to claim 7, wherein:
said plurality of caches comprise solid state disks (SSDs).

9. The invention according to 8, wherein:
said SSDs are partitioned into areas for file-cache and for block-cache, said first cache is RAM, and said SSDs are hot-swappable.

10. The invention according to claim 8, wherein:
the controller communicates with said second cache comprising SSDs when IO demand with the controller exceeds a predetermined threshold, and said first cache is RAM.

11. The invention according to claim 10, wherein:
the controller communicates with said SSD cache when IO demand is above a first predetermined level, and communicates with said RAM when IO demand is below said first predetermined level, wherein cache allocation is performed dynamically.

12. A method for dynamic cache allocation by a RAID controller comprising the steps of:
controlling a plurality of RAID drives through a RAID controller;
caching data from a first cache and the RAID controller;
caching data from a second cache and the RAID controller;
communicating between said RAID controller and the second cache after the RAID controller communicates with the first cache and obtains a cache miss;
wherein cache allocation is performed dynamically.

13. The method according to claim 12, further comprising the steps of:
creating the second cache out of a solid state disk (SSD).

14. The method according to claim 13, further comprising the steps of:
creating a plurality of solid state disks (SSDs).

15. The method according to claim 14, further comprising the steps of:
the plurality of SSDs are scalable and hot-swappable; and,
creating the first cache out of RAM.

16. The method according to claim 14, further comprising the steps of:
partitioning the SSDs into areas for file-cache and for block-cache;
defining the SSDs capacity and percentage of reservation to some predetermined level;
making the first cache from RAM; and,
wherein the controller communicates with said SSDs when IO demand with the controller exceeds a predetermined limit.

17. The method according to claim 13, further comprising the steps of:
communicating between the controller and the SSDs when IO demand with the controller exceeds a predetermined limit.

18. The method according to claim 17, further comprising the steps of:
communicating between the controller and the SSD cache when IO demand is above a first predetermined level, and continuing communication between the controller and SSD cache so long as IO demand stays above the first predetermined level;
constructing the first cache from RAM;
communicating between the controller the RAM when IO demand drops below the first predetermined level.

19. A RAID controller apparatus for dynamic cache allocation comprising:
means for controlling a plurality of drives comprising a RAID;
means for caching data comprising a first cache for caching data from said plurality of drives and communicating with said RAID controller, said first cache comprises RAM;
means for caching data comprising a second cache for caching data from said plurality of drives and communicating with said RAID controller, said second cache comprises a solid state disk (SSD); and,
wherein the controller communicates with said SSDs when IO demand with the controller exceeds a predetermined limit, said controller communicating with said second cache after communicating with said first cache and obtaining a cache miss.

20. The invention of claim 19, comprising:
said controller communicates with said SSDs when IO demand with the controller exceeds a predetermined limit; and,
said SSDs are hot-swappable.
